(19) United States
(12) Patent Application Publication
(10) Pub. No.: US 2026/0097343 A1
(43) Pub. Date: Apr. 9, 2026

(54) AIR FILTER BOX WITH TAPERED INTERFACE SURFACE

(71) Applicant: K&N Engineering, Inc., Corona, CA (US)

(72) Inventors: Gilbert Heck, Corona, CA (US); Steve Williams, Cherry Valley, CA (US)

(73) Assignee: K&N Engineering, Inc., Corona, CA (US)

(21) Appl. No.: 19/351,820

(22) Filed: Oct. 7, 2025

Related U.S. Application Data
(60) Provisional application No. 63/704,347, filed on Oct. 7, 2024.

(51) Int. Cl. B01D 46/00; B01D 46/24

(52) U.S. Cl. CPC B01D 46/0005; B01D 46/2403; B01D 2265/06; B01D 2279/60

(57) ABSTRACT

An apparatus and methods are provided for an air filter box for conducing filtered air to an air intake of an internal combustion engine. The air filter box includes a housing that communicates an airstream to an air filter in an interior of the housing. An opening in the housing retains a mount portion of the air filter. A tapered female surface bordering the opening receives a tapered male surface of the mount portion. The tapered surfaces establish an airtight seal when the air filter is installed into the interior of the air filter box. The mount portion includes a locking lip and an insertion stop flange. The insertion stop flange prevents the mount portion from traveling too far into the interior of the air filter box. The locking lip engages with an internal edge of the tapered female surface when the tapered male surface contacts the tapered female surface.

### PRIORITY

This application claims the benefit of and priority to U.S. Provisional Application, entitled “Air Filter Box With Tapered Interface Surface,” filed on Oct. 7, 2024, and having application Ser. No. 63/704,347, the entirety of said application being incorporated herein by reference.

### FIELD

Embodiments of the present disclosure generally relate to engine air intake systems. More specifically, embodiments of the disclosure relate to an apparatus and methods for an air filter box with a tapered interface surface for conducing filtered air to an air intake duct of an internal combustion engine.

### BACKGROUND

An air filter designed to remove particulate is generally a device composed of fibrous materials. These fibrous materials may remove solid particulates such as dust, pollen, mold, and bacteria from the air. Air filters are used in applications where air quality is important, notably in building ventilation systems and in engines.

Air filters may be used in automobiles, trucks, tractors, locomotives and other vehicles that use internal combustion engines. Air filters may be used with gasoline engines, diesel engines, or other engines that run on fossil fuels or other combustible substances. Air filters may be used with engines in which combustion is intermittent, such as four-stroke and two-stroke piston engines, as well as other types of engines that take in air so that a combustible substance may be burned. For example, air filters may be used with some gas turbines. Filters may also be used with air compressors or in other devices that take in air.

Filters may be made from pleated paper, foam, cotton, spun fiberglass, or other known filter materials. Generally, the air intakes of internal combustion engines and compressors tend to use either: paper, foam, or cotton filters. Some filters use an oil bath. Air filters for internal combustion engines prevents abrasive particulate matter from entering the engine's cylinders, where it would cause mechanical wear and oil contamination. Many fuel injected engines utilize a flat panel pleated paper filter element. This filter is usually placed inside an enclosed, plastic box connected to a throttle body by way of ductwork. Vehicles that use carburetors or throttle body fuel injection systems typically use a cylindrical air filter positioned above the carburetor or the throttle body.

A drawback to enclosed air boxes that require flat panel paper filters is that as particulate matter builds up in the filter, air flow through the filter becomes restricted. Such a restricted air flow generally leads to a reduction in engine performance, such as a decrease in engine power output and a greater fuel consumption. Moreover, as the paper filter becomes increasingly clogged, pressure inside the filter decreases while the atmospheric air pressure outside the filter remains the same. When the difference in pressure becomes too great, contaminants may be drawn through the paper filter directly into the engine. Thus, the ability of the paper filter to protect the engine from contamination and internal damage tends to decrease near the end of the filter's service life. Paper air filters typically are removed from the vehicle and discarded, and a new paper air filter is then installed. Considering that there are millions of vehicles throughout the world, the volume of discarded air filters that could be eliminated from landfills is a staggering number.

Another drawback to enclosed air boxes is that they typically conduct air through a tortuous path of hoses or ductwork before the air enters the intake of the engine. In some cases, the air box is a greater source of air restriction than is the paper filter. Similar to a contaminated air filter, a restrictive air box decreases engine performance and fuel economy. What is needed, therefore, is an air intake system which exhibits reduced air resistance and includes an air filter that can be periodically cleaned and reused.

### SUMMARY

An apparatus and methods are provided for an air filter box for conducing filtered air to an air intake of an internal combustion engine. The air filter box includes a housing that communicates an airstream to an air filter in an interior of the housing. An opening in the housing retains a mount portion of the air filter. A tapered female surface bordering the opening receives a tapered male surface of the mount portion. The tapered surfaces establish an airtight seal when the air filter is installed into the interior of the air filter box. The mount portion includes a locking lip and an insertion stop flange. The insertion stop flange prevents the mount portion from traveling too far into the interior of the air filter box. The locking lip engages with an internal edge of the tapered female surface when the tapered male surface contacts the tapered female surface.

In an exemplary embodiment, an air filter box for remove particulate matter and contaminants flowing with an airstream into an air intake duct of an internal combustion engine, comprises: a housing comprising a rigid material; at least one air inlet for communicates an airstream into an interior of the housing; and an opening in the housing to receive an air filter.

In another exemplary embodiment, the housing is configured to support the air filter and provide an interface between an interior of the air filter and the air intake duct of the engine. In another exemplary embodiment, the housing comprises a material that is sufficiently durable and temperature resistant to retain its configuration during operation when coupled with the air intake duct of the engine.

In another exemplary embodiment, the opening is configured to receive and retain a mount portion of the air filter. In another exemplary embodiment, the opening is bordered by a tapered female surface configured to receive a tapered male surface comprising the mount portion. In another exemplary embodiment, the tapered female surface contacts the tapered male surface when the air filter is installed into the interior of the air filter box. In another exemplary embodiment, the tapered female surface and the tapered male surface are disposed at an angle with respect to a longitudinal axis that is perpendicular to the opening. In another exemplary embodiment, the angle facilitates inserting the air filter into the opening and establishing an airtight seal between the tapered female surface and the tapered male surface.

In another exemplary embodiment, the air filter includes a filter medium disposed between a cap and a mount portion. In another exemplary embodiment, the mount portion comprises a suitably flexible material that is amenable to being pushed through the opening. In another exemplary embodiment, the mount portion is configured to engage with the opening comprising the air filter box and support the air filter in the interior of the air filter box. In another exemplary embodiment, the mount portion includes a tapered male surface disposed between a locking lip and an insertion stop flange.

In another exemplary embodiment, the tapered male surface is configured to establish an airtight seal with a tapered female surface comprising the opening. In another exemplary embodiment, the insertion stop flange prevents the mount portion from traveling too far into the interior of the air filter box. In another exemplary embodiment, the locking lip engages with an internal edge of the tapered female surface when the tapered male surface contacts the tapered female surface. In another exemplary embodiment, the mount portion includes an integrated radial entry that shares a wall with a radius flex point. In another exemplary embodiment, the radial entry reduces air turbulence by smoothing out airflow through the mount portion. In another exemplary embodiment, the radial entry and the radius flex point are configured to reduce stress in the mount portion when the air filter is pushed into the opening of the air filter box.

In another exemplary embodiment, the cap comprises a material that is sufficiently hard to retain the filter medium in a desired configuration and support the air filter when coupled to the air filter box. In another exemplary embodiment, the cap is molded onto a wire support coupled with the filter medium.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a perspective view of an exemplary embodiment of an air filter system, according to the present disclosure;

FIG. 2 illustrates an exploded view of an exemplary embodiment of an air filter system in accordance with the present disclosure;

FIG. 3 illustrates a side view of an exemplary embodiment of the air filter system of FIG. 2, according to the present disclosure;

FIG. 4 illustrates a cross-sectional view of the air filter system of FIG. 3, taken along line 4-4, in accordance with the present disclosure;

FIG. 5 illustrates a close-up view of an exemplary embodiment of a mount portion comprising the air filter system of FIG. 4, within detail area 5, according to the present disclosure;

FIG. 6 illustrates a perspective view of an air filter comprising a mount portion that is compatible with the air filter system of FIG. 2, according to the present disclosure;

FIG. 7 illustrates a bottom view of the air filter of FIG. 6, in accordance with the present disclosure; and

FIG. 8 illustrates a cross-sectional view of the air filter of FIG. 7, taken along line 8-8, in accordance with the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the air filter box and methods disclosed herein may be practiced without these specific details. In other instances, specific numeric references such as “first conduit,” may be made. However, the specific numeric reference should not be interpreted as a literal sequential order but rather interpreted that the “first conduit” is different than a “second conduit.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and methods for an air filter box with a tapered interface surface for conducing filtered air to an air intake of an internal combustion engine. The air filter box includes a housing that communicates an airstream to an air filter in an interior of the housing. An opening in the housing retains a mount portion of the air filter. A tapered female surface bordering the opening receives a tapered male surface of the mount portion. The tapered surfaces establish an airtight seal when the air filter is installed into the interior of the air filter box. The mount portion includes a locking lip and an insertion stop flange. The insertion stop flange prevents the mount portion from traveling too far into the interior of the air filter box. The locking lip engages with an internal edge of the tapered female surface when the tapered male surface contacts the tapered female surface.

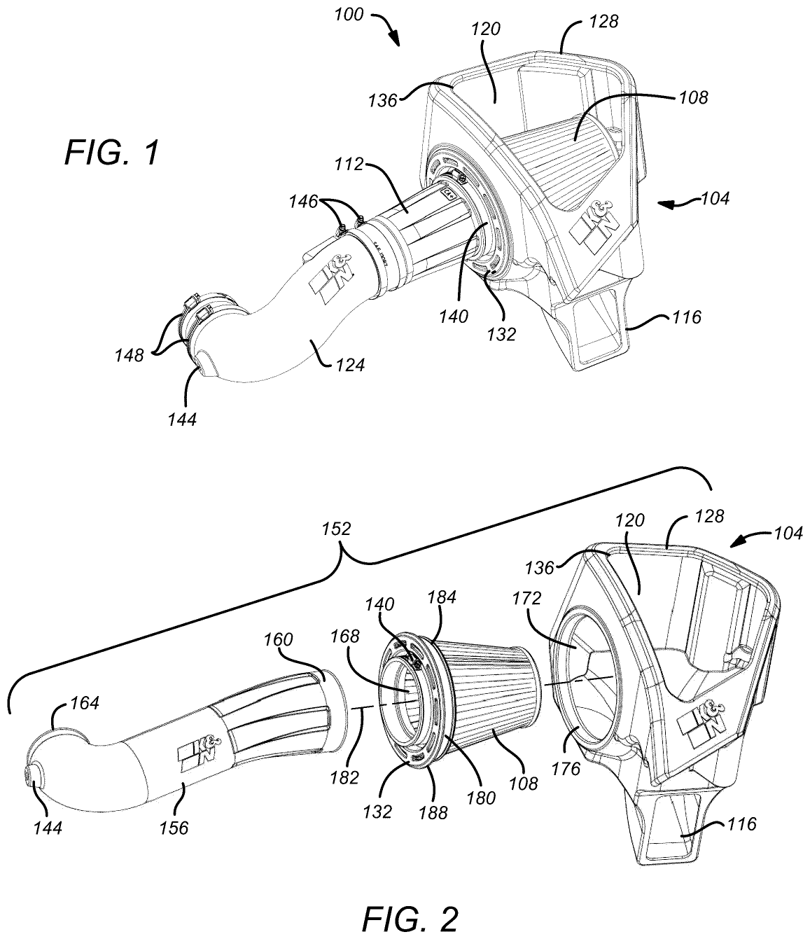

FIG. 1 illustrates an exemplary embodiment of an air filter system 100 (hereinafter, “system 100”), according to the present disclosure. The system 100 includes an air filter box 104 that contains an air filter 108 coupled with an optional hydrocarbon trap 112. The air filter box 104 includes at least one air inlet 116 that communicates an airstream into an interior 120 of the air filter box 104. The air filter 108 is disposed within the interior 120 and configured to remove particulate matter and contaminants that may be flowing with the airstream before the airstream passes through the hydrocarbon trap 112 and then is directed through a conduit 124 to an air intake duct of the internal combustion engine. The optional hydrocarbon trap 112 absorbs evaporative hydrocarbon emissions leaking from the air intake duct when the internal combustion engine is not operating.

The air filter box 104 generally comprises a housing 128 that is configured to improve movement of the airstream through the air filter 108. The housing 128 is configured to support the air filter 108 and provides an interface between an interior of the air filter 108 and the air intake duct of the engine. As shown in the illustrated embodiment, the housing 128 receives a mount portion 132 comprising a portion of the air filter 108. The mount portion 132 is configured to facilitate coupling the air filter 108 with the housing 128 and establish an airtight connection between the interior of the air filter 108 and the air intake duct of the engine. As described herein, the mount portion 132 supports the air filter 108 inside the air filter box 104 and also supports the optional hydrocarbon trap 112 and/or the conduit 124 outside the air filter box 104.

The housing 128 preferably comprises a material that is sufficiently durable and temperature resistant to retain its configuration during operation when coupled with the air intake duct of the engine. It is envisioned that the housing 128 may be formed by way of injection molding, or another similar technique. Moreover, the housing 128 can include an opening 136 that provides access to the interior 120 of the air filter box 104. The opening 136 may be configured to allow unhindered airflow to the air filter 108 and may be used to install and/or service the air filter 108. In some embodiments, however, the opening 136 may be configured to receive cover (not shown) that may be fasted onto the housing 128 to enclose the air filter 108.

In the embodiment illustrated in FIG. 1, the conduit 124 extends from the optional hydrocarbon trap 112 to the air intake duct of the engine. The conduit 124 can comprise a smoothly transitioning arrangement of curved portions that depend upon the particular vehicle for which the system 100 is intended to be used. As such, a wide variety of different arrangements of smoothly transitioning curved portions may be contemplated, without limitation, depending upon the vehicle into which the system 100 is to be installed. The conduit 124 may comprise one or more flanges or other fittings configured to receive various ventilation hoses or sensors extending from the engine. In the illustrated embodiment of FIG. 1, for example, the conduit 124 comprises a flange 144 configured to receive a crankcase ventilation hose (not shown).

As will be appreciated, the conduit 124 is configured to be coupled to the air intake duct of the engine and the optional hydrocarbon trap 112 by way of suitable fasteners. For example, as shown in FIG. 1, a pair of clamps 146 fasten the conduit 124 to the hydrocarbon trap 112 while a pair of clamps 148 are used to maintain an airtight seal between the conduit 124 and the air intake duct of the engine.

FIG. 2 illustrates an exploded view of an exemplary embodiment of an air filter system 152 (hereinafter, “system 152”) in accordance with the present disclosure. The system 152 is substantially similar to the system 100, shown in FIG. 1, with the exception that the system 152 includes a conduit 156 in lieu of the optional hydrocarbon trap 112 and conduit 124 comprising system 100. In the embodiment illustrated in FIG. 2, the conduit 156 extends from the air filter 108 to the air intake duct of the engine. The conduit 156 can comprise a smoothly transitioning arrangement of curved portions that depend upon the particular vehicle for which the system 152 is intended to be used. As such, a wide variety of different arrangements of smoothly transitioning curved portions may be contemplated, without limitation, depending upon the vehicle into which the system 152 is to be installed.

The conduit 156 may comprise one or more flanges or other fittings configured to receive various ventilation hoses or sensors extending from the engine. In the illustrated embodiment of FIGS. 2-4, for example, the conduit 156 comprises a flange 144 configured to receive a crankcase ventilation hose (not shown). Further, the conduit 156 includes a flange 160 and an adapter 164. The flange 160 is configured to be received into an opening 168 comprising the mount portion 132 of the air filter 108. The flange 160 can be secured to the mount portion 132 by way of a clamp 140, as shown in FIG. 2. The adapter 164 is configured to be coupled with the air intake duct of the internal combustion engine. As such, the specific shape of the conduit 156, the flange 160, and the adapter 164 will depend upon the particular vehicle for which the system 152 is intended to be used. As such, a wide variety of different arrangements of flanges, adapters, and smoothly transitioning curved portions may be contemplated, without limitation, depending upon the vehicle into which the system 152 is to be installed.

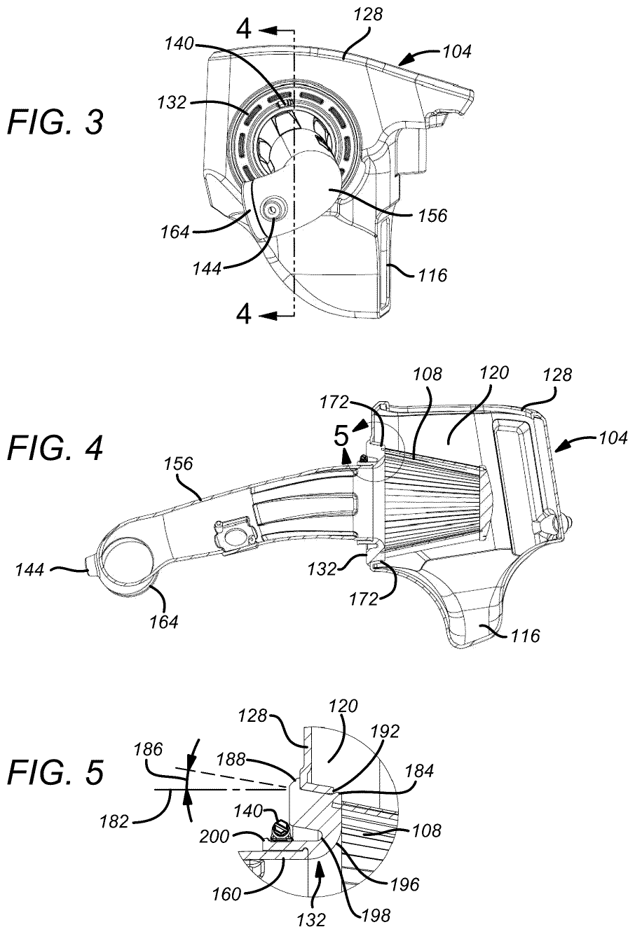

As mentioned hereinabove, the air filter box 104 is configured to support the air filter 108 within an interior 120 of the air filter box 104, as best shown in FIGS. 3-4. As shown in FIG. 2, the air filter box 104 includes an opening 172 that is configured to receive and retain the mount portion 132 of the air filter 108. More specifically, the opening 172 is bordered by a tapered female surface 176 that is configured to receive a tapered male surface 180 comprising the mount portion 132. Thus, the air filter 108 can be installed into the interior 120 of the air filter box 104 by inserting the air filter 108 into the opening 172 until the tapered male surface 180 contacts the tapered female surface 176, as shown in FIGS. 4-5.

As shown in greater detail in FIG. 5, the tapered female and male surfaces 176, 180 are disposed at an angle 186 with respect to a longitudinal axis 182 that is perpendicular to the opening 172. In the illustrated embodiment, the angle 186 between the longitudinal axis 182 and the tapered female and male surfaces 176, 180 is about 10 degrees. In some embodiments, however, the angle 186 can be greater than or lesser than 10 degrees, without limitation. It is contemplated that the angle 186 can have any value that is found to facilitate inserting the air filter 108 into the opening 172 and establishing an airtight seal between the tapered female and male surfaces 176, 180, without limitation.

As best shown in FIG. 5, the tapered male surface 180 is disposed between a locking lip 184 and an insertion stop flange 188. As will be appreciated, the insertion stop flange 188 is configured to prevent the mount portion 132 from traveling too far into the interior 120 of the air filter box 104. Thus, the insertion stop flange 188 contacts the exterior of the housing 128 when the tapered male surface 180 advantageously contacts the tapered female surface 176. The locking lip 184 serves to engage with an internal edge 192 of the tapered female surface 176 when the tapered male surface 180 advantageously contacts the tapered female surface 176. Put another way, during installation of the air filter 108, the locking lip 184 is compressed through the opening 172 until the locking lip 184 pops into place on the other end of the internal edge 192 and bottoms out on the tapered female surface 176. It is contemplated that the mount portion 132 comprises a suitably flexible material that is amenable to being pushed through the opening 172.

As further shown in FIG. 5, the mount portion 132 includes an integrated radial entry 196 that shares a wall with a radius flex point 198. The radial entry 196 is configured to reduce air turbulence by smoothing out the airflow into the conduit 156 while also relieving tension from the system 152 by sharing a wall with the radius flex point 198. More specifically, the radial entry 196 and the radius flex point 198 provide relatively greater amenability of the mount portion 132 to reduce stress in the system 152 when the air filter 108 is pushed into the opening 172 of the air filter box 104. Once the air filter 108 is installed into the opening 172, the conduit 156 can be installed into the mount portion 132 by inserting the flange 160 into a clamp flange 200 and then tightening the clamp 140.

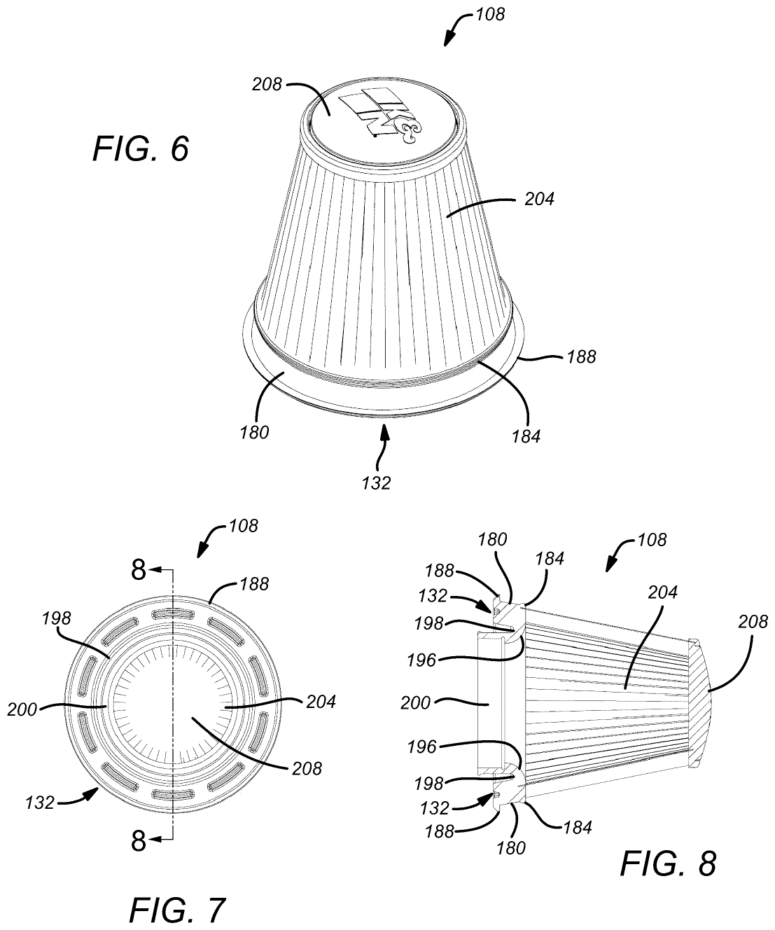

Turning, now, to FIGS. 6-8, an exemplary embodiment of an air filter 108 comprising a mount portion 132 that is compatible with the air filter box 104 of FIGS. 1-4 is shown in greater detail. The air filter 108 comprises a filter medium 204 disposed between a cap 208 and a mount portion 132. As described herein, the air filter 108 is installed into the interior 120 of the air filter box 104 such that an intake airstream is directed around the cap 208 to an exterior of the filter medium 204, drawn through the filter medium 204 into an interior of the air filter 108, and then drawn through the conduit 156 into the air intake duct of the internal combustion engine. The filter medium 204 is configured to remove contaminants and particulate matter from the airstream that is drawn into the air intake duct. The filter medium 204 is a cone shaped member having a diameter that tapers as a function of distance from the mount portion 132 along the filter medium 204. The cap 208 serves to direct the intake airstream around the top-most portion of the air filter 108 and into the filter medium 204. It is contemplated that the cap 208 can be comprised of a rigid material suitable for withstanding the temperature and pressure encountered within the air filter box 104.

In the embodiment of the air filter 108 illustrated in FIGS. 6-8, the mount portion 132 has a diameter that is greater than the diameter of the cap 208. In some embodiments, however, the diameter of the mount portion 132 may be substantially similar to the diameter of the cap 208. It should be understood that the air filter 108 is not limited to the exact shape illustrated in the drawings, but rather the shape of the air filter 108 may include a wide variety of generally cylindrical, circular, oval, round, curved, or other closed perimeter shapes, that provide a relatively large surface area of the filter medium 204. Further, the specific configuration of the air filter 108 should be understood to depend upon the particular make and model of the engine for which the air filter 108 is to be utilized, and thus a wide variety of heights and diameters of the filter medium 204 may be incorporated into the air filter 108 without straying beyond the scope of the present disclosure.

As described herein, the mount portion 132 is configured to engage with an opening 172 comprising the air filter box 104 and support the air filter 108 in the interior 120 of the air filter box 104. The mount portion 132 includes a tapered male surface 180 disposed between a locking lip 184 and an insert stop flange 188. The tapered male surface 180 is configured to establish an airtight seal with a tapered female surface 176 comprising the opening 172. The insertion stop flange 188 prevents the mount portion 132 from traveling too far into the interior 120 of the air filter box 104 while the locking lip 184 engages with an internal edge 192 (see FIG. 5) of the tapered female surface 176 when the tapered male surface 180 advantageously contacts the tapered female surface 176. It is contemplated that the mount portion 132 comprises a suitably flexible material that is amenable to being pushed through the opening 172.

As described in detail with respect to FIG. 5, the tapered female and male surfaces 176, 180 are disposed at an angle 186 with respect to a longitudinal axis 182 that is perpendicular to the opening 172. In the illustrated embodiment, the angle 186 between the longitudinal axis 182 and the tapered female and male surfaces 176, 180 is about 10 degrees. In some embodiments, however, the angle 186 can be greater than or lesser than 10 degrees, without limitation. It is contemplated that the angle 186 can have any value that is found to facilitate inserting the air filter 108 into the opening 172 and establishing an airtight seal between the tapered female and male surfaces 176, 180, without limitation.

As further shown in FIGS. 5 and 8, the mount portion 132 includes an integrated radial entry 196 that shares a wall with a radius flex point 198. The radial entry 196 reduces air turbulence by smoothing out the airflow into the conduit 156 while also relieving tension from the system 152 by sharing the wall with the radius flex point 198. The radial entry 196 and the radius flex point 198 provide relatively greater amenability of the mount portion 132 to reduce stress in the mount portion 132 when the air filter 108 is pushed into the opening 172 of the air filter box 104. Once the air filter 108 is installed into the opening 172, a flange 160 comprising the conduit 156 can be inserted into a clamp flange 200 of the mount portion 132 and then a clamp 140 (see FIG. 5) can be tightened to form an airtight seal between the conduit and the air filter 108.

Turning, again, to FIGS. 6-8, the cap 208 may be affixed to the filter medium 204 by way of any of a variety of fasteners (not shown) or suitable adhesives. In some embodiments, the cap 208 may be molded onto a wire support coupled with the filter medium 204. In some embodiments, the cap 208 may be crimped around its peripheral edge such that it folds onto and retains the wire support and the filter medium 204. Any of various fastening means may be practiced for attaching the filter medium 204 and the wire support to the cap 208, without limitation. Further, the cap 208 preferably comprises a material that is sufficiently hard to retain the filter medium 204 in a desired configuration and support the air filter 108 when coupled to the air filter box 104.

In general, the filter medium 204 provides a surface area through which to pass the intake airstream and entrap particulates and other contaminates flowing with the intake airstream. The filter medium 204 may be comprised of paper, foam, cotton, spun fiberglass, or other known filter materials, woven or non-woven materials, synthetic or natural, or any combination thereof. The filter medium 204 may be pleated, or otherwise shaped, or contoured so as to increase the surface area for passing the intake airstream to be cleaned. The length of the filter medium 204 in the circumferential direction may be longer than the circular circumference of the air filter 108 generally, such that the surface area of the filter medium 204 is greater than the profile surface area of the air filter 108.

As mentioned above, some embodiments of the air filter 108 may include a wire support incorporated into the filter medium 204. Incorporating the wire support into the filter medium 204 provides additional strength and durability to the air filter 108. For example, the filter medium 204 may be positioned between the wire support and one or more layers of a reinforcing material. The wire support may be comprised of wire screens positioned on an outer surface and an inner surface of the filter medium 204. In some embodiments, the filter medium 204 may comprise 4 to 6 layers of cotton gauze that are sandwiched between two epoxy-coated aluminum wire screens. It is contemplated that the wire screens may be co-pleated along with the filter medium 204 to reinforce the air filter 108. Further, the cotton gauze may be advantageously treated with a suitably formulated filter oil composition that causes tackiness throughout microscopic strands comprising the filter medium 204. The nature of the cotton allows high volumes of airflow, and when combined with the tackiness of the filter oil composition creates a powerful filtering medium which ensures a high degree of air filtration.

It is contemplated that the air filter 108 may be serviced and reused by periodically cleaning the filter medium 204 rather than discarding the entire air filter 108, as is done with conventional air filters. In one embodiment, a cleaning method comprises removing the air filter 108 from the air filter box 104. The air filter 108 can be cleaned by inserting a water hose through the clamp flange 200 into the interior and then spraying water to flush contaminants from the filter medium 204. In some embodiments, the method for cleaning the air filter 108 may comprise utilizing a high pressure air hose in lieu of the water hose. In some embodiments, the method for cleaning the air filter 108 may comprise spraying water onto the exterior of the filter medium 204 to flush contaminants directly from the exterior of the filter medium 204. It is contemplated that any water and contaminants that are forced through the filter medium 204 may exit the interior through the clamp flange 200. Other cleaning methods will be apparent to those skilled in the art without deviating from the spirit and scope of the present disclosure.

While the air filter box and methods have been described in terms of particular variations and illustrative figures, those of ordinary skill in the art will recognize that the air filter box is not limited to the variations or figures described. In addition, where methods and steps described above indicate certain events occurring in certain order, those of ordinary skill in the art will recognize that the ordering of certain steps may be modified and that such modifications are in accordance with the variations of the air filter box. Additionally, certain of the steps may be performed concurrently in a parallel process, when possible, as well as performed sequentially as described above. To the extent there are variations of the air filter box, which are within the spirit of the disclosure or equivalent to the air filter box found in the claims, it is the intent that this patent will cover those variations as well. Therefore, the present disclosure is to be understood as not limited by the specific embodiments described herein, but only by scope of the appended claims.

What is claimed is:

1. An air filter box for remove particulate matter and contaminants flowing with an airstream into an air intake duct of an internal combustion engine, comprising:
a housing comprising a rigid material;
at least one air inlet for communicates an airstream into an interior of the housing; and
an opening in the housing to receive an air filter.

2. The air filter box of claim 1, wherein the housing is configured to support the air filter and provide an interface between an interior of the air filter and the air intake duct of the engine.

3. The air filter box of claim 1, wherein the housing comprises a material that is sufficiently durable and temperature resistant to retain its configuration during operation when coupled with the air intake duct of the engine.

4. The air filter box of claim 1, wherein the opening is configured to receive and retain a mount portion of the air filter.

5. The air filter box of claim 4, wherein the opening is bordered by a tapered female surface configured to receive a tapered male surface comprising the mount portion.

6. The air filter box of claim 5, wherein the tapered female surface contacts the tapered male surface when the air filter is installed into the interior of the air filter box.

7. The air filter box of claim 5, wherein the tapered female surface and the tapered male surface are disposed at an angle with respect to a longitudinal axis that is perpendicular to the opening.

8. The air filter box of claim 7, wherein the angle facilitates inserting the air filter into the opening and establishing an airtight seal between the tapered female surface and the tapered male surface.

9. The air filter box of claim 1, wherein the air filter includes a filter medium disposed between a cap and a mount portion.

10. The air filter box of claim 9, wherein the mount portion comprises a suitably flexible material that is amenable to being pushed through the opening.

11. The air filter box of claim 9, wherein the mount portion is configured to engage with the opening comprising the air filter box and support the air filter in the interior of the air filter box.

12. The air filter box of claim 11, wherein the mount portion includes a tapered male surface disposed between a locking lip and an insertion stop flange.

13. The air filter box of claim 12, wherein the tapered male surface is configured to establish an airtight seal with a tapered female surface comprising the opening.

14. The air filter box of claim 13, wherein the insertion stop flange prevents the mount portion from traveling too far into the interior of the air filter box.

15. The air filter box of claim 14, wherein the locking lip engages with an internal edge of the tapered female surface when the tapered male surface contacts the tapered female surface.

16. The air filter box of claim 9, wherein the mount portion includes an integrated radial entry that shares a wall with a radius flex point.

17. The air filter box of claim 16, wherein the radial entry reduces air turbulence by smoothing out airflow through the mount portion.

18. The air filter box of claim 16, wherein the radial entry and the radius flex point are configured to reduce stress in the mount portion when the air filter is pushed into the opening of the air filter box.

19. The air filter box of claim 9, wherein the cap comprises a material that is sufficiently hard to retain the filter medium in a desired configuration and support the air filter when coupled to the air filter box.

20. The air filter box of claim 19, wherein the cap is molded onto a wire support coupled with the filter medium.
